(19) United States
(12) Patent Application Publication
(10) Pub. No.: US 2015/0012858 A1
(43) Pub. Date: Jan. 8, 2015

(54) MOBILE INFORMATION TERMINAL

(71) Applicant: Funai Electric Co., Ltd., Daito-shi (JP)

(72) Inventor: Yusuke TAKENAKA, Daito-shi (JP)

(21) Appl. No.: 14/316,832

(22) Filed: Jun. 27, 2014

(30) Foreign Application Priority Data
Jul. 2, 2013 (JP) 2013-139155

(51) Int. Cl. G06F 3/0486; G06F 3/0485; G06F 3/0482

(52) U.S. Cl. CPC G06F 3/0486; G06F 3/0482; G06F 3/0485
USPC 715/769; 715/810; 715/784

(57) ABSTRACT

A mobile information terminal includes a display unit which displays a drawing screen, a touch panel which accepts operations by a user in the drawing screen and that includes a selection list region which displays picture components constituting candidates for input and a selection reflecting region which displays selected one(s) of the picture components, and a control unit which performs a first control to move a picture component displayed in the selection list region to the selection reflecting region based on a singular first operation that is performed in a first direction from the selection list region toward the selection reflecting region in a state in which the user is touching the picture component, and a second control to return the picture component to the selection list region again based on a singular second operation that is performed in a second direction opposite to the first direction in a state in which the user is touching the picture component.

### BACKGROUND OF THE INVENTION

1. Field of the Invention

The present invention relates to a mobile information terminal and particularly to a mobile information terminal including a touch panel.

2. Description of the Related Art

Mobile information terminals equipped with a touch panel have been known (for example, see Japanese Patent Application Laid-Open Publication No. 2012-230527).

Japanese Patent Application Laid-Open Publication No. 2012-230527 discloses an electronic device (mobile information terminal) equipped with a display screen (display unit) which displays a plurality of thumbnails (selection items) as a list and a touch panel which accepts touch input. This electronic device is configured such that, when a user performs a slide operation, a thumbnail that is on the path of the slide operation is selected from among the plurality of thumbnails displayed on the display screen. Furthermore, the electronic device is configured such that, after a thumbnail is selected, the selected thumbnail is determined by selecting an OK thumbnail.

Moreover, in the creation of pictures or text, a mobile information terminal is known to display on a display unit a region for displaying selection items that serve as constituent elements of a picture or text (selection list region) and a display region in which the selected selection items are combined (selection reflecting region). With such a conventional mobile information terminal, the configuration is considered to be such that after a selection item is selected, the selection is separately determined by some other means.

However, in conventional mobile information terminals, after a selection item is selected, it is necessary to determine the selection separately by some other means. As a result, in order to combine a plurality of selection items, an action is required to determine the selection every time a selection item is selected, which poses a problem in that operability is poor.

### SUMMARY OF THE INVENTION

Preferred embodiments of the present invention provide a mobile information terminal with which a plurality of selection items are combined by simple operations.

A mobile information terminal according to a preferred embodiment of the present invention includes a display unit configured to display an input screen; a touch panel configured to accept operations by a user when a specified object is to be completed by combining a plurality of selection items constituting candidates for input in the input screen that is displayed on the display unit and that includes a selection list region configured to display the selection items and a selection reflecting region configured to display selected one(s) of the selection items; and a control unit configured and programmed to perform a first control to move any one of the selection items displayed in the selection list region to the selection reflecting region based on a singular first operation that is performed in a first direction from the selection list region toward the selection reflecting region in a state in which the user is touching the selection item and a second control to return the selection item, which has been moved from the selection list region to the selection reflecting region, to the selection list region again based on a singular second operation that is performed in a second direction which is the direction opposite to the first direction in a state in which the user is touching the selection item.

A mobile information terminal according to a preferred embodiment of the present invention includes a control unit configured and programmed to perform a first control to move a selection item displayed in the selection list region to the selection reflecting region based on a singular first operation that is performed in a first direction from the selection list region toward the selection reflecting region in a state in which the user is touching the selection item and a second control to return the selection item moved from the selection list region to the selection reflecting region back to the selection list region again based on a singular second operation that is performed in a second direction that is the direction opposite to the first direction in a state in which the user is touching the selection item. By doing so, a selection item is moved from the selection list region to the selection reflecting region by a singular operation, so a plurality of selection items are combined by simple operations. As a result, pictures, text, and the like that are composed of a plurality of selection items are created easily. In addition, not only are selection items displayed in the selection list region moved to the selection reflecting region, but the selection items are also returned from the selection reflecting region to the selection list region. Therefore, selection items are repeatedly moved between the selection list region and the selection reflecting region. Accordingly, even when an unintended selection item is moved to the selection reflecting region by mistake, the selection item is easily returned to the selection list region again by a simple operation, so the operability of the mobile information terminal is increased even in the case of using a compact touch panel with which unintended selection items are likely to be moved by mistake.

In the mobile information terminal according to a preferred embodiment of the present invention, the control unit is preferably configured and programmed to perform a third control to delete any one of the selection items displayed in the selection list region from the selection list region based on a singular third operation that is performed in the second direction in a state in which the user is touching the selection item displayed in the selection list region. If such a configuration is adopted, a selection item that is not needed by the user is easily deleted from the selection list region by a singular third operation, and only those selection items required by the user are displayed in the selection list region.

In the mobile information terminal according to a preferred embodiment of the present invention, the control unit is preferably configured and programmed to perform a control such that, when any one of the selection items is moved by the first control, one of the selection items that is different from the moved selection item is displayed such that it fills in the portion where the moved selection item had been displayed. With such a configuration, there is never a state in which the portion where the moved selection item had been displayed is blank, so it is possible to present many selection items to the user by effectively utilizing the limited region that displays the selection items.

In the mobile information terminal according to a preferred embodiment of the present invention, the first operation and the second operation are preferably configured so as to be performed by either flick actions, drag actions, or swipe actions. By using such a configuration, the user performs the first operation and the second operation by intuitive and simple actions on a touch panel.

In the configuration in which the control unit performs the third control based on the third operation, the third operation is preferably configured so as to be performed by either a flick action, drag action, or swipe action. By adopting such a configuration, the user performs the third operation by an intuitive and simple action on a touch panel.

In the mobile information terminal according to a preferred embodiment of the present invention, the selection list region is preferably configured such that it scrolls automatically. When so configured, some of the selection items in the selection list region that are not displayed on the display unit can be referenced even without the user performing any scroll operation, so the operability of the mobile information terminal is further increased.

It is preferable that the mobile information terminal according to a preferred embodiment of the present invention is configured such that the color and size of any of the selection items displayed in the selection list region can be changed, and that it is configured such that the selection item whose color and size have been changed is moved from the selection list region to the selection reflecting region based on the first operation by the user in a state in which the color and size have been changed. If such a configuration is adopted, the selection items are combined in the selection reflecting region after adding changes of color and size in the selection list region, so the color and size of a selection item group (e.g., a picture or text) formed by combining in the selection reflecting region can be changed in units of the selection items.

In this case, the mobile information terminal is preferably configured such that it is possible to disassemble a selection item group including a plurality of the selection items into individual selection items and then to add the plurality of disassembled selection items to the selection list region. With such a configuration, selection items deemed unnecessary by the user within the selection item group are deleted, and selection items are moved to the selection reflecting region after the color and size are changed in the selection list region in units of the selection items, which are constituent elements of the selection item group. As a result, it is possible to create a selection item group whose form has been modified, so the selection item group is easily changed into the form desired by the user.

In the mobile information terminal according to a preferred embodiment of the present invention, it is preferable that the selection items include picture components, and that the control unit be configured and programmed to combine the picture components via the first control based on the first operation and the second control based on the second operation, thus creating a single picture as the specified object. By using such a configuration, a picture is created by combining a plurality of picture components by simple operations.

In the mobile information terminal according to a preferred embodiment of the present invention, it is preferable that the selection items include characters, and that the control unit be configured and programmed to combine the characters via the first control based on the first operation and the second control based on the second operation, thus creating a single text as the specified object. By adopting such a configuration, text is created by combining a plurality of characters by simple operations.

Preferred embodiments of the present invention provide a mobile information terminal with which a plurality of selection items are combined by simple operations as described above.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing the overall configuration of the mobile information terminal according to a first preferred embodiment of the present invention.

FIG. 2 is a plan view showing the mobile information terminal according to the first preferred embodiment of the present invention.

FIG. 3 is a diagram for illustrating an operation that disassembles a picture based on the mobile information terminal according to the first preferred embodiment of the present invention.

FIG. 4 is a diagram for illustrating an operation that moves a picture component from the selection list region to the selection reflecting region based on the mobile information terminal according to the first preferred embodiment of the present invention.

FIG. 5 is a diagram for illustrating an operation that moves a picture component from the selection reflecting region to the selection list region based on the mobile information terminal according to the first preferred embodiment of the present invention.

FIG. 6 is a diagram for illustrating an operation that deletes a picture component from the selection list region based on the mobile information terminal according to the first preferred embodiment of the present invention.

FIG. 7 is a diagram for illustrating automatic scrolling based on the mobile information terminal according to the first preferred embodiment of the present invention.

FIG. 8 is a diagram for illustrating the enlargement of a picture component based on the mobile information terminal according to the first preferred embodiment of the present invention.

FIG. 9 is a diagram for illustrating an operation that moves characters from the selection list region to the selection reflecting region based on the mobile information terminal according to a second preferred embodiment of the present invention.

FIG. 10 is a diagram for illustrating an operation that deletes characters from the selection list region based on the mobile information terminal according to the second preferred embodiment of the present invention.

### DETAILED DESCRIPTION OF THE PREFERRED EMBODIMENTS

Preferred embodiments of the present invention will be described below based on drawings.

### First Preferred Embodiment

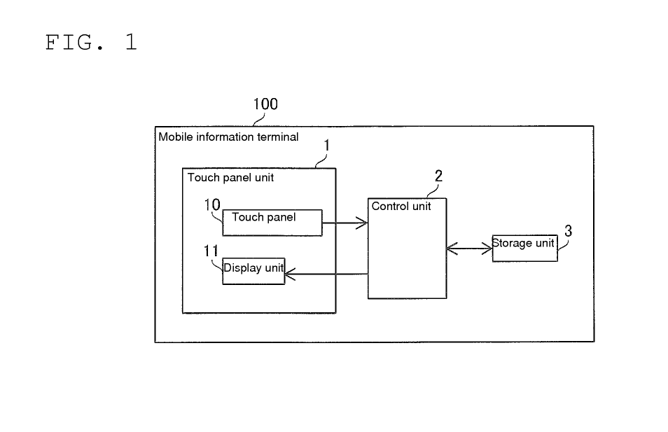

The configuration of the mobile information terminal 100 according to a first preferred embodiment of the present invention will be described with reference to FIGS. 1 through 8.

A mobile information terminal 100 according to the first preferred embodiment of the present invention preferably includes a touch panel unit 1, a control unit 2 connected to the touch panel unit 1, and a storage unit 3 as shown in FIG. 1.

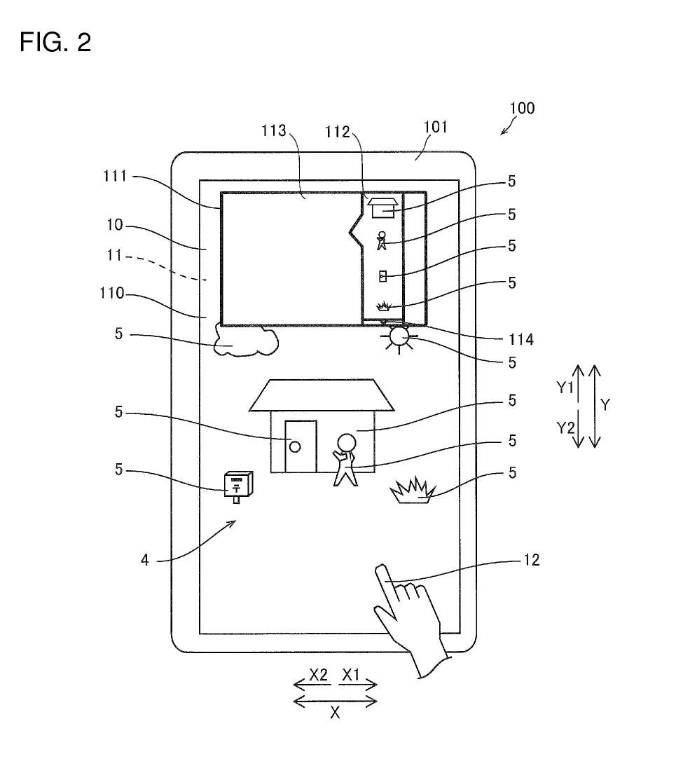

Furthermore, the touch panel unit 1, as shown in FIGS. 1 and 2, includes a touch panel 10 that accepts the content of input operations performed with the use of a stylus, a finger 12 of a user, or the like, and a display unit 11 disposed on the underside of the touch panel 10 (on the inner side of the mobile information terminal 100) and is a liquid crystal panel or the like. Moreover, the mobile informational terminal 100 is configured such that a user can use an application for creating a picture 4 to perform desired editing by performing specified operations by the user on picture components 5 which are constituent elements of the picture 4 displayed on the display unit 11. Note that the picture 4 is configured from a plurality of picture components 5 that are independent of each other. Because of this, the picture 4 is configured such that it can be disassembled into picture components 5. In addition, the individual picture components 5 are configured so as to be arranged at predetermined specified positions within the picture 4. Note that the picture 4 is one example of the “selection item group” and “specified object”. Furthermore, the picture components 5 are examples of the “selection items”.

The touch panel 10, as shown in FIG. 2, is provided over substantially the entire area of the surface 101 on one side of the mobile information terminal 100 that preferably has a rectangular or substantially rectangular flat plate shape. Moreover, the touch panel 10 is configured by a resistive film system in which an input operation is detected by the change in resistance value when the input operation occurs, a capacitive system in which an input operation is detected by the change in static capacitance when the input operation occurs, or another such system.

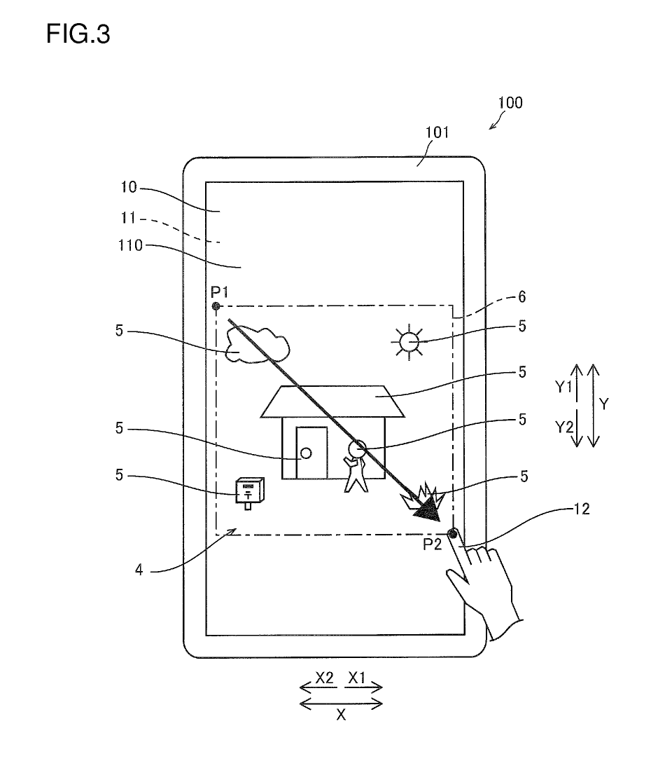

The display unit 11 is configured such that, when an application A is started, the picture 4 is displayed on a specified drawing screen 110 as shown in FIG. 2. Note that, in the case shown in FIG. 2, the drawing screen 110 corresponds to the entire area of the display unit 11. Moreover, as shown in FIGS. 2 and 3, the display unit 11 is configured so as to disassemble a portion or all of the picture 4 on the drawing screen 110 that is identified by a specified operation by the user into the picture components 5, which are constituent elements of the picture 4, and also so as to display the disassembled picture components 5 on a window 111 to edit the picture 4. The window 111 is configured so as to be displayed on a portion of the drawing screen 110 by the specified operation that disassembles the picture 4. To elaborate this, the window 111 is configured from a selection list region 112 that lines up and displays the picture components 5 obtained by disassembling the picture 4 displayed on the drawing screen 110 and a selection reflecting region 113 that creates a new picture by selecting and combining picture components 5 of the selection list region 112. In addition, the display unit 11 is configured so as to display the selection list region 112 toward the X1 direction of the window 111 and display the selection reflecting region 113 toward the X2 direction of the window 111. Note that details of the disassembly of the picture 4 displayed on the drawing screen 110 and of the creation of the new picture 4 on the window 111 will be described later. Furthermore, the drawing screen 110 is one example of the “input screen”.

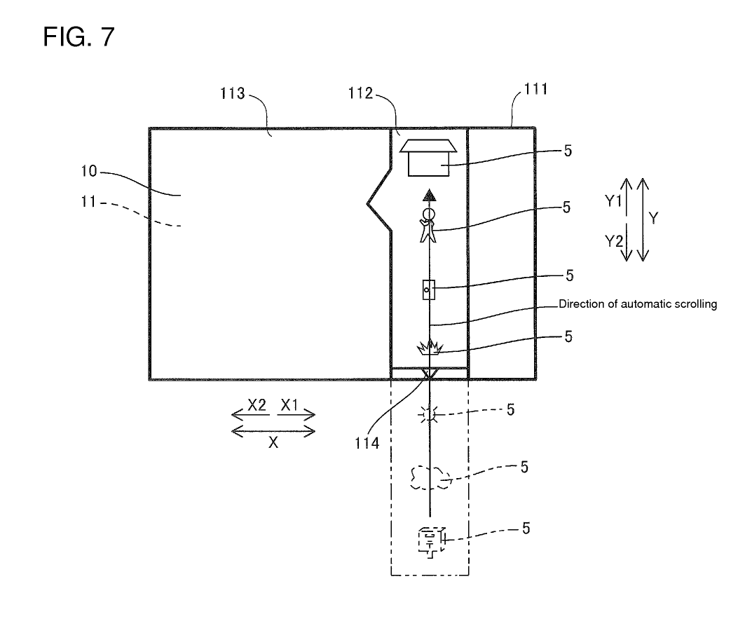

Moreover, as shown in FIG. 7, the selection list region 112 is configured so as to have a plurality of picture components 5 lined up along the top-down direction (Y direction) and so as to automatically scroll upward (in the Y1 direction). For this reason, the display unit 11 is configured so as to display, in order, the picture components 5 depicting the sun, clouds, and a mailbox that are not displayed in the window 111 (the picture components 5 shown in two-dot chain lines) instead of the picture components 5 depicting a house, a person, a door, and a plant that are displayed in the window 111. In addition, the selection list region 112 is configured so as to scroll at a faster rate than the automatic scroll described above when the user operates a scroll operating unit 114.

The control unit 2 is configured and programmed to control the individual components of the mobile information terminal 100. Furthermore, the control unit 2 is configured and programmed to receive an input signal based on the operation of the touch panel 10 by the user. Moreover, the control unit 2 is configured and programmed to control the display unit 11 by outputting an output signal to the display unit 11 based on the input signal received from the touch panel 10. The control unit is configured and programmed to perform control for the purpose of creating a new picture 4 on the window 111 of the display unit 11 based on the user's operation of the touch panel 10.

Here, in the first preferred embodiment, the control unit 2 is configured so as to create a new picture 4 that combines picture components 5 on the window 111 by performing a first control which moves picture components 5 from the selection list region 112 to the selection reflecting region 113 based on a first flick operation that involves the user flicking in a first direction (in the direction from the selection list region 112 to the selection reflecting region 113, or X2 direction), a second control which moves picture components 5 from the selection reflecting region 113 to the selection list region 112 based on a second flick operation that involves the user flicking in a second direction (in the direction opposite to the first direction, or X1 direction), and a third control which deletes picture components 5 from the selection list region 112 based on a third flick operation that involves the user flicking in the second direction (X1 direction). Note that “flick” refers to an action in which the finger 12 or the like lightly touches the touch panel 10 and is then moved on the touch panel 10 as though it were picked, like the string of a guitar. In addition, details of the first flick operation, second flick operation, and third flick operation will be described later. Furthermore, the first flick operation, second flick operation, and third flick operation are, respectively, examples of the “first operation,” “second operation,” and “third operation”.

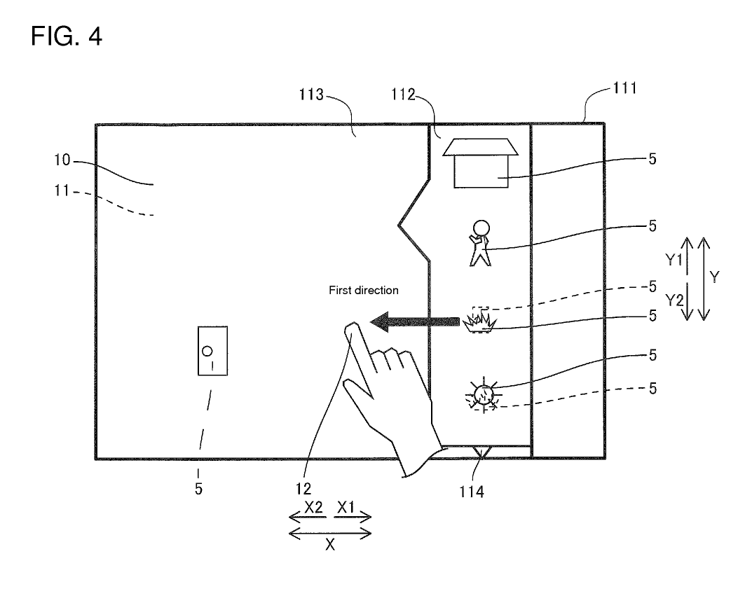

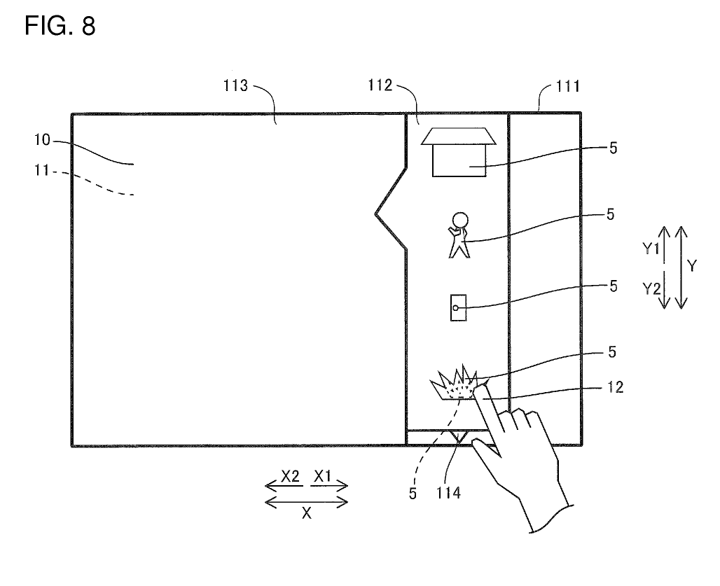

Moreover, the control unit 2 is configured and programmed such that the color and size of the picture components 5 displayed in the selection list region 112 can be changed. For example, as shown in FIG. 8, the control unit 2 is also configured and programmed such that, in cases where the user's finger 12 touches the picture component 5 depicting a plant for longer than a specified period of time, the touched picture component 5 depicting a plant can be automatically enlarged or reduced, and its color can also be switched. The configuration is also such that, by performing the first control (see FIG. 4) based on the first flick operation by the user, the picture component 5 whose color and size have been changed is moved from the selection list region 112 to the selection reflecting region 113 in a state in which the color and size have been changed.

The storage unit 3 is configured so as to store data such as the picture components 5. In addition, the storage unit 3 is configured such that it also stores the picture components deleted from the selection list region 112 by the third control described above. Accordingly, the mobile information terminal 100 is configured such that the picture components 5 that have been deemed unnecessary by the user and deleted from the selection list region 112 are restored to the selection list region 112.

Next, disassembly of the picture 4 displayed on the drawing screen 110 will be described with reference to FIG. 3.

A single picture 4 is formed on the drawing screen 110 from the picture components 5 depicting a house, person, door, plant, sun, cloud, and mailbox as shown in FIG. 3. Then, the disassembling of the picture 4 displayed on the drawing screen 110 is performed based on a user operation that selects the picture 4 to be disassembled. To elaborate this, the user touches a point P1 on the touch panel 10 with the finger 12 and then slides it in a diagonal direction (in the X1 direction and in the Y2 direction) across the picture 4 (picture components 5). Then, the user ends the slide (lifts the finger 12 off the touch panel 10) at a point P2. At the time of this operation, the display unit 11 displays on the drawing screen 110 a rectangle 6 (the rectangle 6 indicated by the one-dot chain line) whose vertices are the opposite points P1 and P2 based on the slide. The picture components 5 that correspond to the region surrounded by this rectangle 6 are then disassembled from the picture 4. Furthermore, the window 111 (see FIG. 2) is displayed on a portion of the drawing screen 110 simultaneous with the termination of the slide at the point P2. Then, the picture components 5 (the picture components 5 which depict a house, person, door, plant, sun, cloud, and mailbox) that are surrounded by this rectangle 6 and disassembled are added to the selection list region 112 of the window 111.

Next, the creation of a new picture 4 in the window 111 will be described with reference to FIGS. 2 through 7.

First, the first flick operation which moves the picture components 5 displayed in the selection list region 112 to the selection reflecting region 113 will be described with reference to FIGS. 2, 4, and 7.

The picture components 5 depicting a house, person, door, and plant are displayed in the selection list region 112 as shown in FIG. 2. Moreover, the picture components 5 depicting a sun, cloud, and mailbox (see FIG. 7) are displayed in the selection list region 112 by scrolling.

For example, when the picture component 5 depicting a door is to be moved from the selection list region 112 to the selection reflecting region 113 through a flick of the user's finger 12 (the first flick operation), the procedure is as follows. First, the user touches the picture component 5. Then, the user flicks in the direction from the selection list region 112 toward the selection reflecting region 113 (in the first direction (X2 direction)). By doing so, the picture component 5 depicting a door moves as though it were flicked toward the first direction (X2 direction) corresponding to the movement of the finger 12 as shown in FIG. 4. As a result, the picture component 5 depicting a door that has been moved to the selection reflecting region 113 is placed at the position where it was displayed on the drawing screen 110 when the picture 4 was disassembled. Furthermore, the picture component 5 depicting a door that has been moved to the selection reflecting region 113 is erased from the selection list region 112.

In this case, the control unit 2 performs control such that, in the case in which the picture component 5 is moved by the first control based on the first flick operation, a picture component 5 that is different from the moved picture component 5 depicting a door (dotted line) is displayed so as to fill in the portion where the moved picture component 5 depicting a door had been displayed. Specifically, the picture component 5 depicting a plant that had been placed below (in the Y2 direction) the picture component 5 depicting a door is moved to be placed at the position in the selection list region 112 where the picture component 5 depicting a door (dotted line) had been placed. Similarly, a picture component 5 depicting the sun (solid line) that had not been displayed in the window 111 is moved from below the window 111 (the Y2 direction) to be placed at the position where the picture component 5 depicting a plant (dotted line) had been placed.

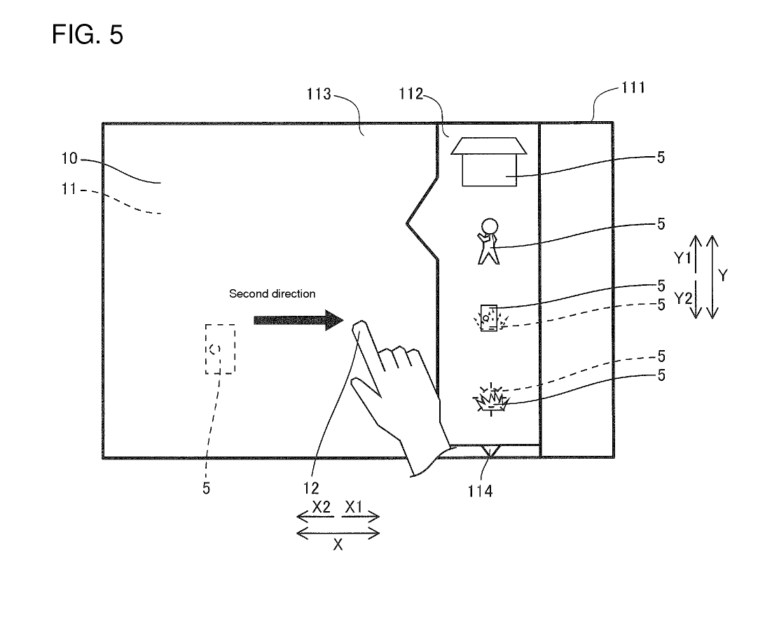

Next, the second flick operation which moves (returns) the picture components 5 displayed in the selection reflecting region 113 to the selection list region 112 will be described with reference to FIG. 5.

The second flick operation differs from the first flick operation in that the operating direction is the opposite (the second direction (X1 direction)) as shown in FIG. 5, and is otherwise similar to the first flick operation. That is, in the second flick operation, a flick is performed in the direction from the selection reflecting region 113 toward the selection list region 112 (in the second direction (X1 direction)). The picture component 5 that has been erased from the selection list region 112 is then re-added to the selection list region 112. Consequently, the picture component 5 depicting a door (solid line) is again placed at the position where the picture component 5 depicting a plant (dotted line) had been placed. Moreover, the picture component 5 depicting a plant (solid line) is again placed at the position where the picture component 5 depicting the sun (dotted line) had been placed. In addition, the picture component 5 that has been moved to the selection list region 112 is erased from the selection reflecting region 113.

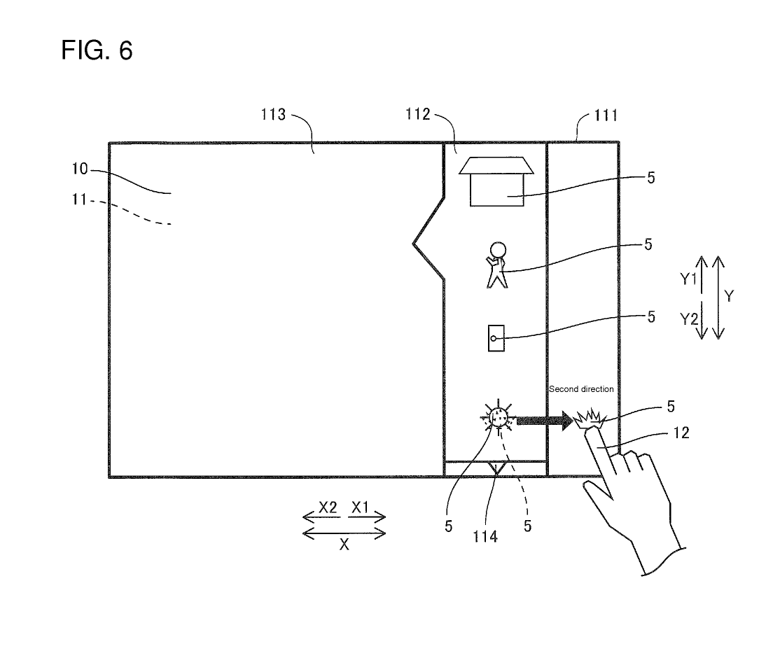

Next, the third flick operation which deletes the picture components 5 displayed in the selection list region 112 will be described with reference to FIG. 6.

For example, when the picture component 5 depicting a plant is to be deleted from the selection list region 112 through a flick of the user's finger 12 (the third flick operation) as shown in FIG. 6, the following procedure is performed. First, the user touches the picture component 5 depicting a plant. Then, the user flicks in the second direction (X1 direction) from the selection list region 112. As a result, the picture component 5 depicting a plant (dotted line) moves as though it were flicked from the selection list region 112 toward the outside of the window 111 corresponding to the movement of the finger 12. As a result, the picture component 5 depicting a plant is deleted from the selection list region 112. Similarly, the picture component 5 depicting the sun (solid line) that had not been displayed in the window 111 is moved from below the window 111 (the Y2 direction) to be placed at the position where the picture component 5 depicting a plant had been placed.

Furthermore, when the task of creating the picture 4 in the selection list region 112 and the selection reflecting region 113 of the window 111 by the first through third flick operations is completed, the new picture 4 created in the selection reflecting region 113 is displayed on the drawing screen 110 by performing a specified operation that closes the window 111.

In the first preferred embodiment, as was described above, the control unit 2 is configured and programmed to perform a first control that moves a picture component 5 displayed in the selection list region 112 to the selection reflecting region 113 based on a singular first flick operation performed in a first direction from the selection list region 112 toward the selection reflecting region 113 in a state in which the user is touching the picture component 5 and a second control that returns the picture component which has been moved from the selection list region 112 to the selection reflecting region 113 back to the selection list region 112 again based on a singular second flick operation performed toward a second direction that is the direction opposite to the first direction in a state in which the user is touching the picture component 5. By doing so, a picture component 5 is moved from the selection list region 112 to the selection reflecting region 113 by a singular operation, so a plurality of picture components 5 are combined by simple operations. As a result, a picture 4 composed of a plurality of picture components 5 is created easily. Moreover, the picture components 5 displayed in the selection list region 112 can not only be moved to the selection reflecting region 113, but the picture components 5 can also be returned from the selection reflecting region 113 to the selection list region 112, thus allowing picture components 5 to be repeatedly moved between the selection list region 112 and the selection reflecting region 113. Accordingly, even when an unintended picture component 5 is moved to the selection reflecting region 113 by mistake, the picture component 5 is easily be returned to the selection list region 112 again, so the operability of the mobile information terminal 100 is increased even in the case of using a compact touch panel 10, with which it is likely to move unintended picture components 5 by mistake.

In addition, in the first preferred embodiment, as was described above, the control unit 2 is configured and programmed to perform a third control that deletes a picture component 5 displayed in the selection list region 112 from the selection list region 112 based on a singular third operation performed in the second direction in a state in which the user is touching the picture component 5 displayed in the selection list region 112. This makes it possible to easily delete a picture component 5 that is not needed by the user from the selection list region 112 by a singular third flick operation and also to display only those picture components 5 required by the user in the selection list region 112.

Furthermore, in the first preferred embodiment, as was described above, the control unit 2 is configured and programmed to perform control such that, when a picture component 5 is moved by the first control, a picture component 5 different from the moved picture component 5 is displayed such that it fills in the portion where the moved picture component 5 had been displayed. By doing so, there is never a state in which the portion where the moved picture component 5 had been displayed is blank, so many picture components 5 are presented to the user by effectively utilizing the limited region that displays the picture components 5.

Moreover, in the first preferred embodiment, the configuration is such that the first flick operation and the second flick operation preferably are performed by flick actions as described above. This makes it possible for the user to perform the first operation and the second operation by intuitive and simple actions on the touch panel 10.

In addition, in the first preferred embodiment, the configuration is such that the third flick operation preferably is performed by a flick action as described above. This allows the user to perform the third operation by an intuitive and simple action on the touch panel 10.

In the first preferred embodiment, furthermore, the selection list region 112 preferably is configured so as to scroll automatically as described above. Consequently, some of the picture components 5 in the selection list region 112 not displayed on the display unit 11 are referenced even without the user performing any scroll operation, so the operability of the mobile information terminal 100 is further increased.

Moreover, as was described above, the first preferred embodiment preferably is configured such that the color and size of the picture components 5 displayed in the selection list region 112 are changed, and it is configured such that a picture component 5 whose color and size have been changed is moved from the selection list region 112 to the selection reflecting region 113 based on the first operation by the user in a state in which its color and size have been changed. This makes it possible to add changes of color and size to the picture components 5 in the selection list region 112 and then to combine them in the selection reflecting region 113, so the color and size of the picture 4 formed by combining in the selection reflecting region 113 are changed in units of the picture components 5.

In addition, as was described above, the first preferred embodiment is configured so as to allow the picture 4 composed of a plurality of picture components 5 to be disassembled into individual picture components 5 and the plurality of disassembled picture components 5 to be added to the selection list region 112. Consequently, it is possible to delete picture components 5 deemed unnecessary by the user within the picture 4 and also to change, in the selection list region, the color and size in units of the picture components 5, which are constituent elements of the picture 4, after which these are moved to the selection reflecting region 113. By doing so, it is possible to create a picture 4 whose form has been modified, so the picture 4 is easily changed into the form desired by the user.

### Second Preferred Embodiment

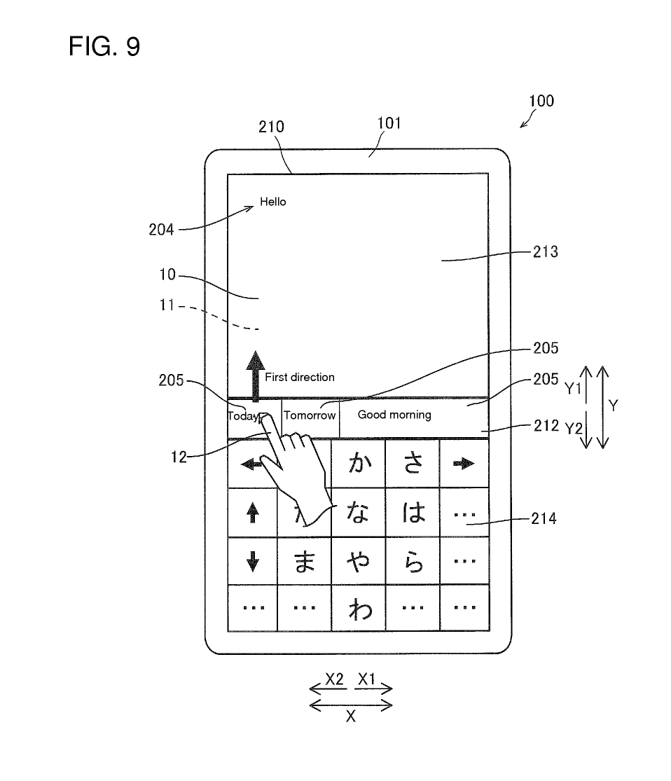

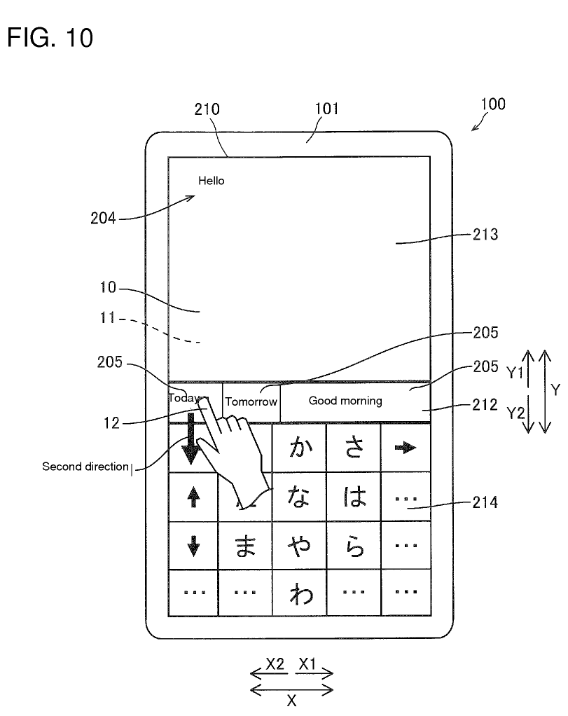

Next, a second preferred embodiment of the present invention will be described with reference to FIGS. 9 and 10.

In this second preferred embodiment, in contrast to the first preferred embodiment which is configured such that a picture 4 is created by combining picture components 5 of the selection list region 112 in the selection reflecting region 113, a description will be given of a mobile information terminal 100 which is configured such that a text 204 is created by operations such as combining characters 205 of a selection list region 212 in a selection reflecting region 213.

The mobile information terminal 100 according to the second preferred embodiment of the present invention is configured so as to enable the text 204 to be created using an application to create the text 204.

As shown in FIG. 9, the display unit 11 of the mobile information terminal 100 is configured such that when the application is started, a specified text input screen 210 to create the text 204 is displayed over the entire area of the display unit 11. This text input screen 210 is configured from the selection reflecting region 213 in which the text 204 is to be created, a software key board 214 enabling entry of characters into the selection reflecting region 213, and the selection list region 212 in which characters 205 likely to follow after the characters that have been entered into the selection reflecting region 213 are predicted and displayed. Note that the prediction of the characters 205 is performed by using the input content history of the user and the like as the basis of this prediction. Furthermore, the display unit 11 is configured so as to display the selection reflecting region 213 toward the Y1 direction of the text input screen 210, display the software keyboard toward the Y2 direction of the text input screen 210, and display the selection list region 212 between the selection reflecting region 213 and the software keyboard 214. Note that the text input screen 210 is one example of the “input screen”. Moreover, the text is one example of the “selection item group” and “specified object”. In addition, the characters 205 are examples of the “selection items”.

Next, a first flick operation which moves the characters 205 displayed in the selection list region 212 to the selection reflecting region 213 will be described with reference to FIG. 9.

The characters “hello” entered using the software keyboard 214 are displayed in the selection reflecting region 213 as shown in FIG. 9. In the selection list region 212, furthermore, the characters 205 representing “today,” “tomorrow,” and “good morning,” which were predicted from the characters “hello,” are displayed.

For example, when the characters 205 representing “today” are to be moved from the selection list region 212 to the selection reflecting region 213 through a flick of the user's finger 12 (the first flick operation), the following procedure is performed. First, the user touches the characters 205 representing “today.” Then, the user flicks in the direction from the selection list region 212 toward the selection reflecting region 213 (in the first direction (Y1 direction)). Doing so moves the characters 205 representing “today” as though they were flicked toward the first direction corresponding to the movement of the finger 12. Moreover, the characters 205 representing “today” that have been moved to the selection reflecting region 213 are erased from the selection list region 212. Note that when the first flick operation is performed such that the user's finger 12 moves between the characters 205 in the text 204, the moved characters 205 are inserted between the characters 205.

Next, a description will be given of a second flick operation which moves the characters 205 displayed in the selection reflecting region 213 to the selection list region 212.

The second flick operation differs from the first flick operation in that the operating direction is the opposite (the second direction), and is otherwise similar to the first flick operation. Specifically, in the second flick operation, a flick is performed in the direction from the selection reflecting region 213 toward the selection list region 212 (in the Y2 direction). Then, the characters 205 that have been erased from the selection list region 212 are re-added to the selection list region 212, and the text 204 is compacted so as to fill in where the characters 205 have been moved from the text 204. As a result, if the characters 205 that have been returned from the text 204 to the selection list region 212 by the second flick operation are moved to a different position within the text 204 using the first flick operation, then the placement of the characters 205 is changed within the text 204.

Next, a third flick operation that deletes the characters 205 displayed in the selection list region 212 will be described with reference to FIG. 10.

For example, when the characters 205 representing “today” are to be deleted from the selection list region 212 using a flick of the user's finger 12 (the third flick operation) as shown in FIG. 10, the procedure is as follows. First, the user touches the characters 205 representing “today.” Then, the user flicks in the second direction (Y2 direction). By doing this, the characters 205 representing “today” move as though they were flicked from the selection list region 212 toward the outside of the text input screen 210 corresponding to the movement of the finger 12. As a result, the characters 205 representing “today” are deleted from the selection list region 212. Then, the characters representing “tomorrow” are moved in the X2 direction to be placed at the position where the characters 205 representing “today” had been placed.

In the second preferred embodiment, as was described above, the control unit 2 is configured and programmed to perform a first control that moves the characters 205 displayed in the selection list region 212 to the selection reflecting region 213 based on a singular first flick operation performed in a first direction from the selection list region 212 toward the selection reflecting region 213 in a state in which the user is touching the characters 205 and a second control that returns the characters 205 which have been moved from the selection list region 212 to the selection reflecting region 213 back to the selection list region 212 again based on a singular second flick operation performed toward a second direction that is the direction opposite to the first direction in a state in which the user is touching the characters 205. By doing so, a plurality of characters 205 are combined by simple operations. As a result, a text 204 including a plurality of characters 205 is created easily.

Note that the preferred embodiments disclosed herein merely constitute illustrative examples in all respects and should be considered to be nonrestrictive. The scope of the present invention is not indicated or determined by the description of the preferred embodiments but rather by the scope of the claims, and includes all modifications and equivalents within the scope of the patent claims.

For instance, in the first and second preferred embodiments, examples were shown in which picture components and characters preferably are moved between the selection list regions and the selection reflecting regions by flick actions; however, the present invention is not limited to this. With the present invention, movement may also be done by swipe actions or drag actions, for example. Note that a swipe is an operation that slides a finger in a set direction while maintaining touch contact with the touch panel. In addition, a drag is an operation that moves a finger in any direction while maintaining touch contact with the touch panel.

Furthermore, in the first preferred embodiment, an example was shown in which a new picture preferably is created by disassembling a picture that is a group of picture components, but the present invention is not limited to this. The present invention may also be configured so as to create pictures from specified picture components without disassembling pictures.

Moreover, in the first preferred embodiment, an example was shown in which the mobile information terminal is configured such that the color and size of the picture components are changed; however, the present invention is not limited to this. The present invention may also be configured such that, in addition to the color and size, the positions of picture components in the selection reflecting region are changed.

In addition, in the first preferred embodiment, an example was shown in which the mobile information terminal preferably is configured such that a window configured of the selection list region and the selection reflecting region is displayed in a portion of the drawing screen, but the present invention is not limited to this. In the present invention, the window may also be displayed in the entire area of the drawing screen. In this case, the drawing screen that displays the picture is displayed translucently because it is overlaid by the window.

Furthermore, in the first preferred embodiment, an example was shown in which the mobile information terminal preferably is configured so as to automatically scroll the selection list region, but the present invention is not limited to this. The present invention may also be configured such that the picture components or characters displayed in the selection list region are switched as a batch at specified intervals without the selection list region automatically scrolling.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A mobile information terminal comprising:
a display unit configured to display an input screen;
a touch panel configured to accept operations by a user when a specified object is to be completed by combining a plurality of selection items constituting candidates for input in the input screen and that includes a selection list region configured to display the selection items and a selection reflecting region configured to display at least a selected one of the selection items; and
a control unit configured and programmed to perform a first control to move one of the selection items displayed in the selection list region to the selection reflecting region based on a first operation that is performed in a first direction from the selection list region toward the selection reflecting region in a state in which the user is touching the one of the selection items and a second control to return the one of the selection items, which has been moved from the selection list region to the selection reflecting region, to the selection list region again based on a second operation that is performed in a second direction opposite to the first direction in a state in which the user is touching the one of the selection items.

2. The mobile information terminal according to claim 1, wherein the control unit is configured and programmed to perform a third control to delete one of the selection items displayed in the selection list region from the selection list region based on a third operation that is performed in the second direction in a state in which the user is touching the one of the selection items displayed in the selection list region.

3. The mobile information terminal according to claim 1, wherein the control unit is configured and programmed to perform a control such that, when one of the selection items is moved by the first control, another one of the selection items different from the moved selection item is displayed such that the another one of the selection items fills in a portion where the moved selection item had been displayed.

4. The mobile information terminal according to claim 1, wherein the first operation and the second operation are configured so as to be performed by at least one of flick actions, drag actions, and swipe actions.

5. The mobile information terminal according to claim 2, wherein the third operation is configured to be performed by at least one of a flick action, a drag action, and a swipe action.

6. The mobile information terminal according to claim 1, wherein the selection list region is configured to scroll automatically.

7. The mobile information terminal according to claim 1, wherein the mobile information terminal is configured such that color and size of one of the selection items displayed in the selection list region is capable of being changed and the selection item whose color and size have been changed is moved from the selection list region to the selection reflecting region based on the first operation by the user in a state in which the color and size have been changed.

8. The mobile information terminal according to claim 7, wherein the mobile information terminal is configured such that it is possible to disassemble a selection item group including a plurality of the selection items into individual selection items and then to add the plurality of disassembled selection items to the selection list region.

9. The mobile information terminal according to claim 1, wherein
the selection items include picture components; and
the control unit is configured and programmed to combine the picture components through the first control based on the first operation and the second control based on the second operation to create a single picture as the specified object.

10. The mobile information terminal according to claim 9, wherein the control unit is configured and programmed to dissemble the combined picture components defining the single picture and add the dissembled picture components to the selection list region.

11. The mobile information terminal according to claim 1, wherein
the selection items include characters; and
the control unit is configured and programmed to combine the characters through the first control based on the first operation and the second control based on the second operation to create a single text as the specified object.

12. The mobile information terminal according to claim 11, wherein the control unit is configured and programmed to dissemble the combined characters defining the single text and add the dissembled characters to the selection list region.

13. The mobile information terminal according to claim 1, wherein the picture elements are repeatedly moved between the selection list region and the selection reflecting region.

14. The mobile information terminal according to claim 1, wherein the mobile information terminal is configured such that a position of one of the selection items displayed in the selection list region is capable of being changed and the selection item whose positions have been changed is moved from the selection list region to the selection reflecting region based on the first operation by the user in a state in which the positions have been changed.

15. The mobile information terminal according to claim 1, wherein the selection list region and the selection reflecting region are displayed together in a window on the input screen.

16. The mobile information terminal according to claim 15, wherein the window occupies a limited portion of the input screen.

17. The mobile information terminal according to claim 15, wherein the window occupies an entirety or substantially an entirety of the input screen.

18. The mobile information terminal according to claim 1, wherein the selection list items include picture components or characters displayed in the selection list region and switched as a batch at specified intervals.
